(19) United States
(12) Patent Application Publication
(10) Pub. No.: US 2022/0105373 A1
(43) Pub. Date: Apr. 7, 2022

(54) INTEGRATED FALL-PROTECTION HARNESSES AND EXOSKELETONS AND METHODS FOR USE

(71) Applicant: ENHANCE TECHNOLOGIES, LLC, San Diego, CA (US)

(72) Inventor: Mark C. Doyle, Del Mar, CA (US)

(21) Appl. No.: 17/500,841

(22) Filed: Oct. 13, 2021

Related U.S. Application Data
(63) Continuation-in-part of application No. PCT/US2020/040769, filed on Jul. 2, 2020.
(60) Provisional application No. 62/869,977, filed on Jul. 2, 2019.

(51) Int. Cl. A62B 35/00; A61H 3/00

(52) U.S. Cl. CPC A62B 35/0025; A62B 35/0018; A61H 3/008; A62B 35/0037; A61H 2201/1638; A61H 2201/164; A61H 2003/007; A61H 2201/1628; A61H 2201/1623

(57) ABSTRACT

Integrated fall-protection harnesses and exoskeletons are disclosed that include cooperating connectors to removably couple the exoskeletons to the harnesses. The exoskeletons may include an arm support including an arm rest for receiving an arm of the user and one or more compensation elements configured to apply an offset force to at least partially offset a gravitational force acting on the arm as the user moves and the arm support follows the movement of the user's arm. Alternatively, the exoskeletons may be permanently mounted to the harnesses.

### RELATED APPLICATION DATA

The present application is a continuation-in-part of co-pending International Application No. PCT/US2020/40769, filed Jul. 2, 2020, which claims benefit of U.S. provisional application Ser. No. 62/869,977, filed Jul. 2, 2019, the entire disclosures of which are expressly incorporated by reference herein.

### FIELD OF THE INVENTION

The present invention relates to fall-protection harnesses and exoskeletons, e.g., to fall-protection harnesses that include integrated and/or removable exoskeletons, e.g., including arm support systems that support one or both of a user's arms, while allowing substantially free motion, e.g., to allow the user to perform one or more tasks for extended periods of time with one or both arms extended.

### BACKGROUND

Many industrial, construction, maintenance, and material handling workers are required to perform their duties at dangerous heights, often on scaffolding, roofs, beams, cliffs, and/or other raised structures. On these jobs, they are often required to wear fall-protection/arrest harnesses. These harnesses are attached to structural connection points via one or more lanyards. If the worker falls during the performance of their task, the harness and lanyard serve to arrest their descent, saving them from severe injury or death.

Harnesses and lanyards are used in preventing a fall (fall-protection) and/or arresting a fall once the worker has fallen (fall-arrest). For brevity, both are herein referred to as fall-protection harnesses.

Exoskeletons are an emerging technology intended to reduce the chronic effects of strain on the arms, shoulders, necks, and backs of workers. The Levitate Airframe® is an example of a passive upper body exoskeleton that is beneficial in reducing such strain. Workers who perform their duties at dangerous heights would also benefit from such an exoskeleton.

It is possible to use exoskeletons in conjunction with fall-protection harnesses, for example, by donning the harness, then donning the exoskeleton on top of the harness. While this combination is functional, it is often not optimal. There can be much duplication of the straps and pads, for example waist belts and shoulder straps. This can add to complication, heat, discomfort, and unnecessary weight. Also, the exoskeleton may interfere with features of the harness.

Thus, there is a need for an integrated fall-protection harness and exoskeleton, which are configured to work seamlessly together.

### SUMMARY

The present invention is directed to fall-protection harnesses and exoskeletons, and, more particularly, to fall-protection harnesses that include integrated and/or removable exoskeletons, e.g., including adaptive arm support systems that support one or both of a user's arms, while allowing substantially free motion, e.g., to allow the user to perform one or more tasks for extended periods of time with one or both arms extended.

In one example, the systems include an integrated fall-protection harness and exoskeleton, in which attachment elements are used to join the exoskeleton to the harness. The harness thus provides the function that the soft parts of a stand-alone exoskeleton otherwise provide, e.g., serving to hold the exoskeleton on the worker, to transfer the load of the worker's arms and tools to their core body (especially the hips), and padding the worker from hard surfaces. Alternatively, padding elements (not shown) can be attached to the exoskeleton, so they are present only when the worker has attached the exoskeleton to the harness.

The harness will generally be made of flexible and softer materials, such as webbing, padding, and the like. The exoskeleton will generally be made of stiffer and harder materials, e.g., metals, such as aluminum, plastic, and/or composite materials, in order to perform its support function. Thus, the connection elements may be capable of joining the soft harness structure to the hard exoskeleton structure, and transmitting the required loads.

In one example, the exoskeleton may be essentially permanently attached to the harness, and thus the two are always worn by the worker. In this embodiment, the exoskeleton and harness may be joined by connection elements that are expected to be used infrequently, if ever, to detach the exoskeleton. In this case, the connection elements may not need to be detachable by the worker in the course of performing their duties, and may be relatively permanent, or at least not rapidly connected or disconnected. Examples of such connection elements are screws and rivets.

In another example, the exoskeleton may be easily attached to, or detached from, the harness by the worker. If the worker prefers to perform part of the task without the exoskeleton, they may leave it unattached, while still safely wearing the harness. If after some time, the nature of the job changes, and an exoskeleton is recommended, the worker may easily don the exoskeleton, e.g., at height, without removing the harness and endangering themselves. This involves attaching the exoskeleton to the harness at various points, using various optional attachment elements.

Many easily used attachment elements are contemplated. In one example, a proprietary connection element includes a secure and easily used “snap” in feature, with guide surfaces to help the user locate and use the feature. Many other connection types are contemplated, including snaps, rivets, screws, buttons, buckles, straps, zippers, cotter pins, detent connectors, dovetails, keyhole connectors, carabiners, hooks, shackles, twist latches, hook and loop fasteners, magnets, magnetic buckles, overall buckle loops, laces, sewing, adhesives, pockets, elastic, or many other connection elements.

In accordance with another example, a fall-protection harness is provided for removably carrying an exoskeleton when worn by a user that includes a pair of leg loops configured to be received around respective thighs of the user; a back panel configured to be positioned against the user's back when the harness is worn; one or more attachment rings for connecting to a lanyard or other structure; a plurality of front straps extending from the back panel and attached to the leg loops, the front straps having a length such that the front straps extend over shoulders of the user to the leg loops when the harness is worn; a plurality of back straps extending from the back panel and attached to the leg loops such that the back straps extend along the user's back when the harness is worn; and one or more connectors for engaging one or more respective connectors on an exoskeleton to couple the exoskeleton to the harness.

In accordance with another example, a fall-protection harness is provided for removably carrying an exoskeleton when worn by a user that includes a pair of leg loops configured to be received around respective thighs of the user; a back panel configured to be positioned against the user's back when the harness is worn; an attachment ring attached to the back panel, e.g., configured for connecting to a lanyard or other structure; a plurality of front straps extending from the back panel and attached to the leg loops, the front straps having a length such that the front straps extend over shoulders of the user to the leg loops when the harness is worn; a plurality of back straps extending from the back panel and attached to the leg loops such that the back straps extend along the user's back when the harness is worn; and one or more connectors for engaging one or more respective connectors on an exoskeleton to couple the exoskeleton to the harness, each connector comprising an open upper end, a relatively narrow lower end defining a recess into which a connector on the exoskeleton may be received, guides extending from the upper end to the lower end to guide the connector from the exoskeleton into a recess, and a lock member that engages the connector on the exoskeleton when the connector is fully seated in the lower end to lock the connectors together.

In accordance with still another example, a fall-protection harness is provided for removably carrying an exoskeleton when worn by a user that includes a pair of leg loops configured to be received around respective thighs of the user; a back panel configured to be positioned against the user's back when the harness is worn; an attachment ring attached to the back panel, e.g., configured for connecting to a lanyard or other structure; a plurality of front straps extending from the back panel and attached to the leg loops, the front straps having a length such that the front straps extend over shoulders of the user to the leg loops when the harness is worn; a plurality of back straps extending from the back panel and attached to the leg loops such that the back straps extend along the user's back when the harness is worn; a waist belt attached to one or both of the front straps and the back straps such that the waist belt extends around the user's waist or hips when the harness is worn; and a plurality of connectors for engaging one or more respective connectors on an exoskeleton to couple the exoskeleton to the harness, the connectors comprising a back connector on the back panel, and a pair of hip connectors at locations corresponding to the user's hips when the harness is worn, each connector comprising an open upper end, a relatively narrow lower end defining a recess into which a connector on the exoskeleton may be received, guides extending from the upper end to the lower end to guide the connector from the exoskeleton into a recess, and a lock member that engages the connector on the exoskeleton when the connector is fully seated in the lower end to lock the connectors together.

In accordance with another example, a system is provided for supporting an arm of a user that includes a harness configured to be worn on a body of a user; an exoskeleton comprising an arm support including an arm rest for receiving the arm of the user and one or more compensation elements configured to apply an offset force to at least partially offset a gravitational force acting on the arm as the user moves and the arm support follows the movement of the user's arm; and one or more cooperating connectors on the harness and exoskeleton for removably mounting the exoskeleton to the harness, each cooperating connector comprising an exoskeleton connector on the exoskeleton, and a harness connector on the harness comprising an open upper end, a relatively narrow lower end defining a recess into which the exoskeleton connector may be received, guides extending from the upper end to the lower end to guide the exoskeleton connector into a recess, and a lock member that engages the exoskeleton connector when fully seated in the lower end to lock the cooperating connectors together.

In accordance with still another example, a method is provided for coupling an exoskeleton to a fall-protection harness that includes donning the fall-protection harness; positioning the exoskeleton such that a back connector tab on a spine strut of the exoskeleton is located adjacent a funnel-shaped harness connector on a back panel of the harness; lowering the exoskeleton relative to the harness to direct the back connector tab into the funnel-shaped harness connector; and directing hip connector tabs on a hip strut of the exoskeleton into corresponding funnel-shaped harness connectors at hip locations on the harness.

In accordance with yet another example, an integrated fall-protection harness and exoskeleton is provided that includes a) a harness configured to be worn on a body of a user comprising: a pair of leg loops configured to be received around respective thighs of the user; a back panel configured to be positioned against the user's back when the harness is worn; one or more attachment rings attached to the back panel, e.g., configured for connecting to a lanyard or other structure; a plurality of front straps extending from the back panel and attached to the leg loops, the front straps having a length such that the front straps extend over shoulders of the user to the leg loops when the harness is worn; and a plurality of back straps extending from the back panel and attached to the leg loops such that the back straps extend along the user's back when the harness is worn; and b) an exoskeleton mounted to the harness comprising an arm support including an arm rest for receiving the arm of the user and one or more compensation elements configured to apply an offset force to at least partially offset a gravitational force acting on the arm as the user moves and the arm support follows the movement of the user's arm.

Other aspects and features of the present invention will become apparent from consideration of the following description taken in conjunction with the accompanying drawings.

### BRIEF DESCRIPTION OF THE DRAWINGS

The present invention is best understood from the following detailed description when read in conjunction with the accompanying drawings. It will be appreciated that the exemplary devices shown in the drawings are not necessarily drawn to scale, with emphasis instead being placed on illustrating the various aspects and features of the illustrated examples.

FIG. 1 is a perspective view of a subject wearing an exemplary fall-protection harness.

FIGS. 2 and 3 are perspective views of a subject wearing an example of a combined exoskeleton and fall-protection harness.

FIG. 4 is a perspective views of a subject wearing another example of a combined exoskeleton and fall-protection harness.

FIG. 5 is a detail of the harness of FIG. 4 showing exemplary connectors for removably coupling the exoskeleton to the harness.

FIG. 6 is a perspective view of an example of an exoskeleton that includes connectors that may be engaged with the harness shown in FIG. 4 to couple the exoskeleton to the harness.

FIGS. 7 and 8 are details showing exemplary connectors that may be used to connect an exoskeleton to a harness.

FIGS. 9A-9C show an exemplary method for using the connectors of FIGS. 7 and 8 to connect an exoskeleton to a harness.

FIG. 10 is a perspective view of another example of a combined exoskeleton and fall-protection harness.

FIGS. 11 and 12 are details showing an optional feature that may be provided on a combined exoskeleton and fall-protection harness.

### DETAILED DESCRIPTION

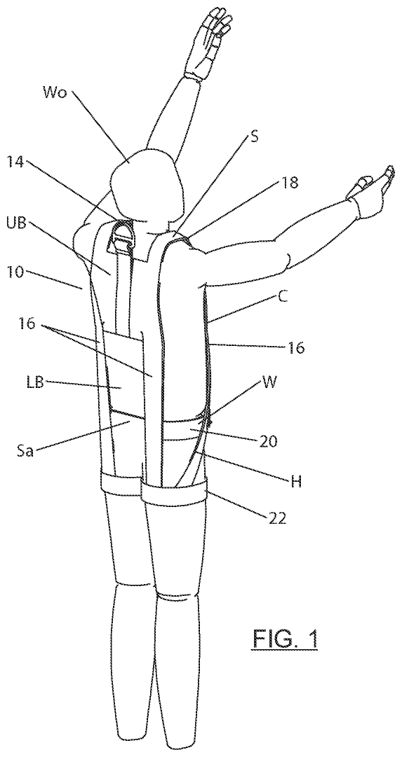

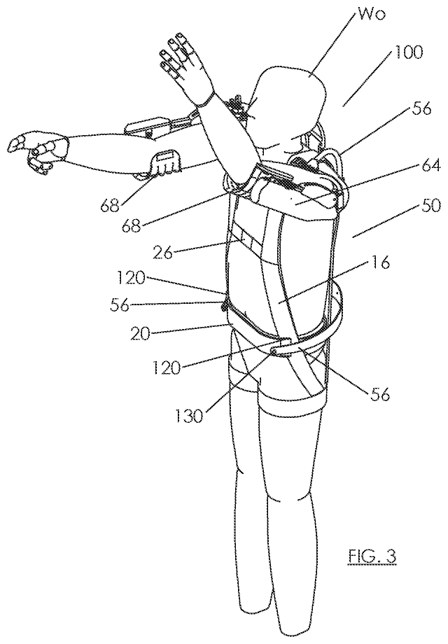

Turning to the drawings, FIG. 1 shows a perspective view of a worker or other user Wo wearing a fall-protection harness 10, which includes one or more D-shaped or other attachment rings, shoulder straps 18, waist belt 20, leg loops 22, and chest strap 26 (not shown, see, e.g., FIG. 3). Also shown in FIG. 1 are possible locations of connection points between an exoskeleton (not shown) and harness 10, e.g., to enable loads in the exoskeleton to be properly transferred to the worker's core body. These include, but are not limited to, the hips H, upper back UB, lower back LB, sacrum Sa, shoulders S, and waist W. As shown, the harness 10 includes a plurality of elongate straps 16, 18 extending vertically and/or diagonally between leg loops 22 located around each thigh of the user Wo and a central region of the harness 10, e.g., a back panel carrying a D-ring 14. For example, a back strap 16 may extend along the user's back downwardly from the back panel to the back of each leg loop 22 and a shoulder strap 18 may be configured to extend from the back panel over each shoulder S and front strap 16 may extend along or across the front of the user's torso to the front or side of each leg loop 22.

Optionally, a waist belt 20 may be attached or otherwise coupled to one or both of the front and back straps 16 and/or a chest strap 26 (shown in FIG. 3) may be attached between the front straps 16. Although only a single D-ring is shown, it will be provided that additional attachment rings or lanyard connectors (not shown) may be provided on the harness 10 as desired, e.g., to removably connect the user to lanyards and/or other structures, as desired.

The components of the harness 10 may be made from conventional materials, e.g., flexible materials such as webbing, padding, canvas, and the like, optionally reinforced as desired, with the components permanently attached together, e.g., using one or more of stitching, fasteners, such as rivets, clips, buttons, and the like, fusing or bonding, and the like.

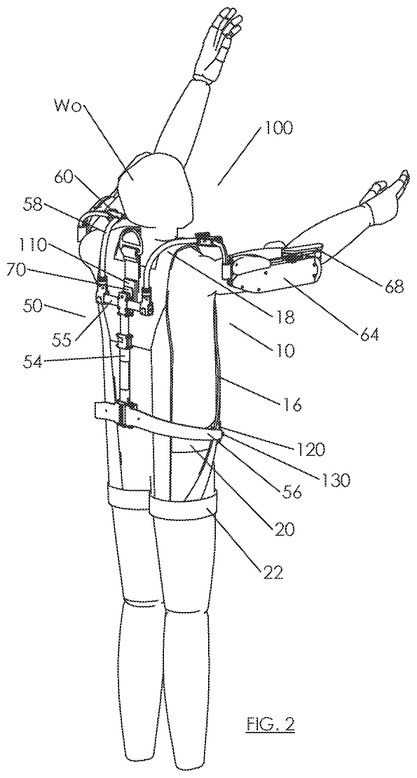

FIG. 2 shows a rear perspective view of a user Wo wearing an example of a combined exoskeleton and fall-protection harness 100, including a fall-protection harness 10 and exoskeleton 50. The exoskeleton 50 may include one or more of the components, e.g., arm supports, frames, compensation elements, etc., such as those disclosed in U.S. Publication Nos. 2012/0184880, 2014/0158839, 2015/0306762, 2015/0316204, 2017/0224517, 2018/0303650, and 2019/0152048, the entire disclosures of which are expressly incorporated by reference herein. In the example shown, the exoskeleton 50 includes a pair of belt struts 56 from which a spine strut 54 extends, e.g., vertically along the user's back, to a cross-bar that supports an arm support for each of the user's arms. The belt struts 56 may be configured to extend at least partially around the waist or hips of the user, e.g., having some flexibility between the spine strut 54 and ends to wrap partially around the user.

Each arm support includes a rigid shoulder bracket member that terminates above the shoulder S, and one or more segments pivotally coupled to the upper end of the shoulder bracket that carry an arm rest 68 and a cassette 64 including one or more compensation elements. For example, as described in the applications incorporated by reference herein, the cassette 64 may contain a spring or other resilient member coupled to one or more cables and/or pulleys to apply an offset force to the upper arm received in the arm rest 68, e.g., to at least partially offset a gravitational force acting on the arm. Optionally, the cassette(s) 64 may be removable and/or may be interchangeable from a set of multiple cassettes providing different offset force profiles.

The exoskeleton 50 may be attached to a harness 10 essentially permanently or by easily detachable/attachable connection elements. It will be appreciated that other exoskeletons may also be integrated with fall-protection harnesses in this way. The exoskeleton 50 may include several elements used to counterbalance the weight of the worker's arms, and the tools they are holding, and distribute it into the worker's core. These include the spine strut 54, belt struts 56, shoulder assemblies 58, cassettes 64, and armrests 68. The purpose and function of these elements are described in the references identified above.

FIG. 3 shows a front perspective view of a user Wo wearing a combined exoskeleton and fall-protection harness 100, showing optional chest strap 26, e.g., attached and extending between front straps 16.

Examples of generic connection points are shown in FIGS. 2 and 3. For example, in FIG. 2, an upper back connector 110 is shown that is permanently attached to the harness 10, and an upper back connector 70 is shown that is permanently attached to the exoskeleton 50, e.g., to the strut 54 or cross-bar, that may be permanently or removably engaged with one another to connect the exoskeleton 50 to the harness 10. The connector 110 may provide an attachment that is essentially permanent, for example, comprising screws, rivets, sewn attachments, and other types of connections that are not easily separated. Alternatively, the connector 110 may be an easily attached or detached connection, for example, including snaps, hooks, buckles, or other rapidly attached and separated elements, such as those described elsewhere herein.

In addition or alternatively, as shown in FIGS. 2 and 3, one or more belt strut connectors 120 may be provided on the harness 10, e.g., on waist belt 10 adjacent the right and left hips of the user Wo, and corresponding belt strut connectors 130 may be provided on the exoskeleton 50, e.g., on opposite ends of the belt strut 56 of the exoskeleton 50 to further connect the exoskeleton 50 to the harness 10. The connector 120 may provide an attachment that is essentially permanent, for example, including screws, rivets, sewn attachments, and other types of connections that are not easily separated. Alternatively, the connector 120 may provide an easily attached or detached connection, for example, comprising snaps, hooks, buckles, or other rapidly attached and separated elements. Other connection points can be so equipped with suitable connection devices.

Optionally, the connectors 110 and 120 (and/or any other connection devices that may be attached to a fall-protection harness 10 to enable attachment of an exoskeleton 50 to the harness 10) may be position-adjustable on the harness 10 or exoskeleton 50, allowing the user to move the connection device to an optimal location, e.g., to accommodate different size users and/or increase comfort. For example, the connector 110 may be movable vertically on the back panel of the harness 10 to adjust the location relative to the user's back and/or the connector 120 may be movable around the waist belt 20 to a desired location relative to the user's hips.

In another option, the connectors 110 and 120 (and/or any other connection devices that may be attached to a fall-protection harness 10 to enable attachment of an exoskeleton 50 to the harness 10) may be either permanently installed on the harness 10 or may be configured to allow the worker to attach the connection device to an existing harness themselves.

Any connection element may be stiff in multiple axes, stiff in only one axis, allow the joint to pivot, be flexible, be rigid, be semi-rigid, or allow translation and/or twisting of the joint.

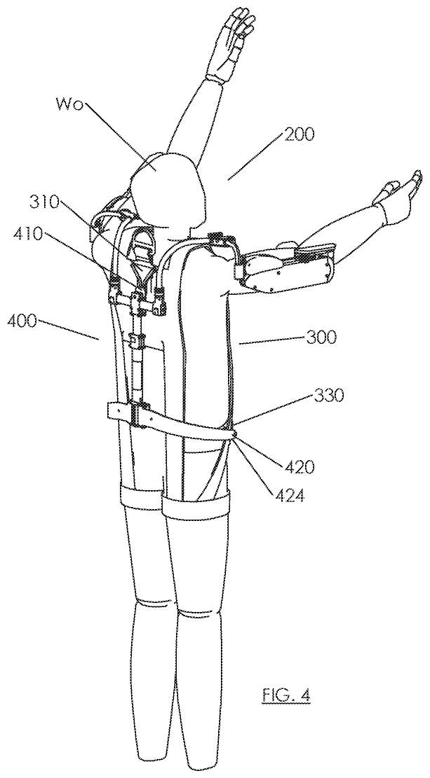

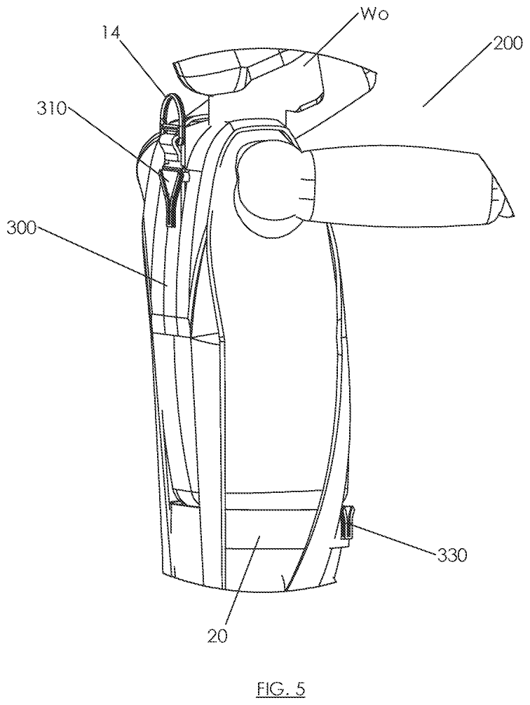

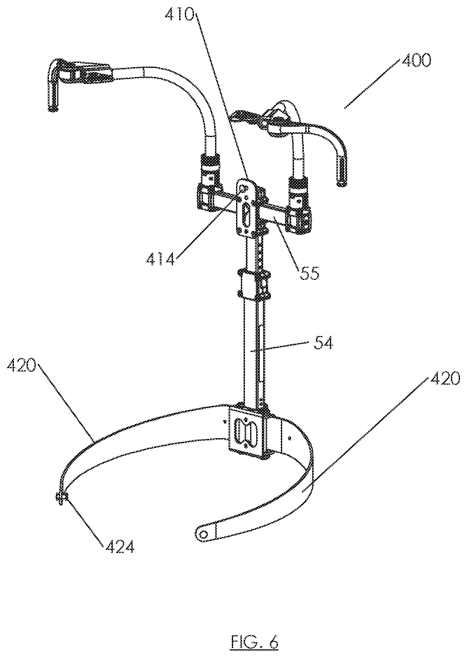

Optionally, the user Wo may have the ability to attach or detach the exoskeleton themselves while safely continuing to wear the harness. Various connection devices may be employed to achieve this. For example, FIG. 4 shows a rear perspective view of a worker Wo wearing a combined exoskeleton and fall-protection harness 200, including cooperating connection elements that allow an exoskeleton 400 to be easily attached to, or detached from, harness 300 by the worker Wo. For example, FIG. 5 shows exemplary harness connection elements 310, 330 that may be provided on the harness 300 that allow cooperating connectors or features 414, 424 on the exoskeleton 400, e.g., as shown in FIG. 6, to be rapidly engaged or disengaged to attach or detach the exoskeleton 400 to (or from) the harness 300.

FIG. 5 shows a rear perspective view of a worker Wo wearing the harness 300 of FIG. 4 to which the harness connection elements 310, 330 are permanently attached. For example, as shown, a back connector 310 may be permanently attached to the back panel of the harness 300, e.g., immediately below D-ring 14. In addition, a pair of hip connectors 330 (one shown) may be provided on the waist belt 20 of the harness 300. Alternatively, the hip connectors may be provided at other locations on the harness 300, e.g., on the front straps or other locations adjacent the user's hips when the harness 300 is worn. Optionally, the hip connectors 330 may be adjustable, e.g., movable laterally along the waist belt 20 to accommodate different users. In addition or alternatively, the back connector 310 and/or hip connectors 330 may be movable vertically, e.g., carried on adjustable straps to accommodate variations in individual user's height or shape.

As will be described in greater detail below, the harness connection elements 310, 330 may be shaped to facilitate positioning, engaging, and/or disengaging the cooperating connectors 414, 424 on the exoskeleton 400, e.g., through funnel-like openings, and may include snap-like detent elements and/or other locking elements to retain the exoskeleton 400 in position on the harness 300.

FIG. 6 shows a front perspective view of the exoskeleton 400 with the cassettes 64 and armrests 68 (such as those shown in FIG. 2) removed for clarity. Cooperating connectors 414, 424 may be provided on the exoskeleton 400, which may be easily engaged with the harness connection elements 310 and 330. In this example, the cooperating connectors 414, 424 are fixed tabs attached or otherwise mounted to the exoskeleton 400, each defining an approximately button-shape, as will be described in greater detail below. For example, as shown, a back tab 414 may be permanently attached to a plate or otherwise mounted to the cross-bar 55, e.g., at a location corresponding to the back connector 310 on the harness 300, and hip tabs 424 may be provided on opposite ends of the hip strut 420, e.g., permanently attached to base plates that are, in turn, attached to the hip strut 420 or directly embedded in and/or otherwise attached to the hip strut 420. Alternatively, if the exoskeleton includes a hip belt or enclosed band configured to completely surround the user's waist or hips (not shown), the hip tabs may be provided at locations that correspond to locations of the hip connectors on the harness.

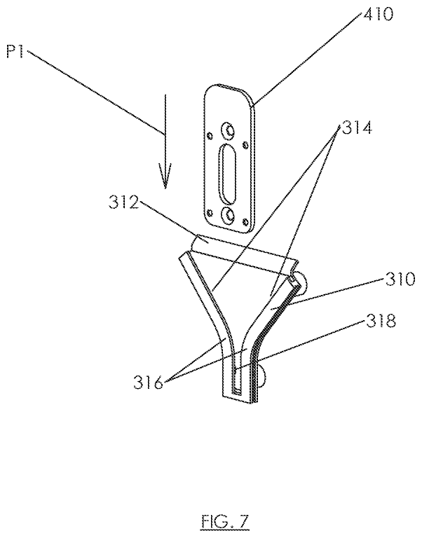

FIG. 7 shows a front perspective view of an individual harness connection element 310 and a corresponding exoskeleton cooperating element 410 during the connection process. User Wo (not shown), already wearing harness 300 (not shown), may hold the exoskeleton 400 adjacent their back, e.g., aligning the spine strut 54 along their back as shown in FIG. 4, and maneuver the cooperating element 410 into the wide funnel-like opening 314 of the harness connection element 310, e.g., generally along path P1, then the user may push or pull the exoskeleton 300 down until it “snaps” into the secured position on the harness 300 (not shown). Snap spring 318 retains the cooperating element 410 until removal of the exoskeleton 400 is desired. Optional curved tab 312 on the connection element 310 may also facilitate insertion and/or locking the harness connection element 310 and the cooperating element 410. Retention flanges 316 retain cooperating tab 414 as described in greater detail below.

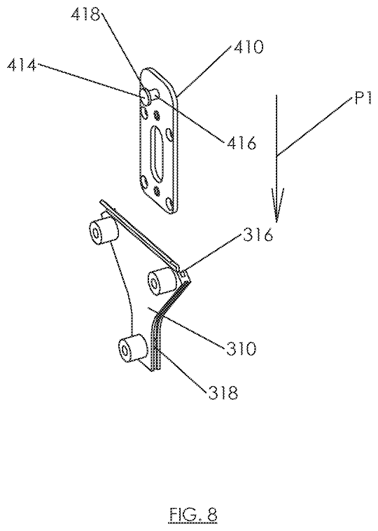

FIG. 8 shows a rear perspective view of this process. In the example shown, the cooperating tab 414 includes a shaft 416 defining a minor diameter or cross-section that terminates in a head 418 defining a major diameter or cross-section, i.e., that is larger than the shaft 416. The head 418 cooperates with retention flanges 316 in the harness connection element 310 to keep the cooperating element 410 attached to the harness connection element 310. For example, the flanges 316 may be spaced apart to accommodate the shaft 416 while defining channels or guides 332 behind which the head 418 may slide to guide the tab 414 into a lower region of the harness connection element 310.

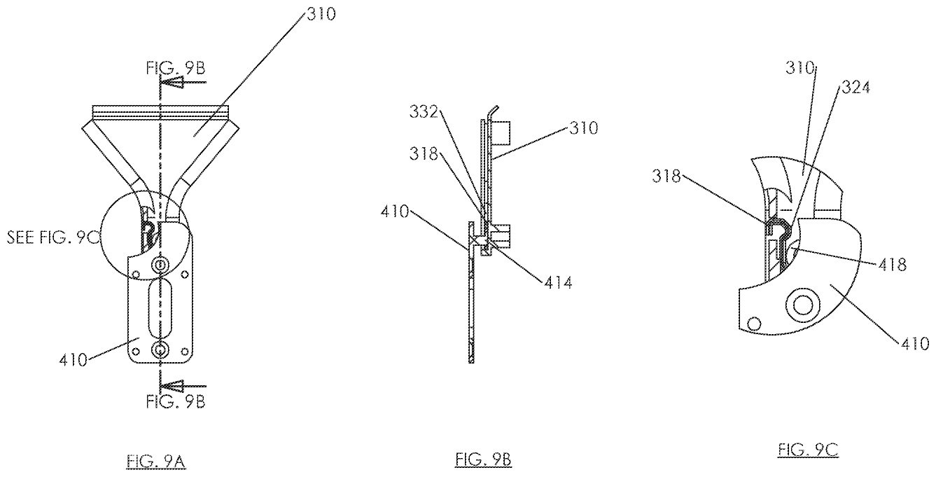

FIG. 9A shows a rear view of the completed process of joining the cooperating element 410 to the harness connection element 310. The cooperating element 410 is fully pushed down into the harness connection element 310. FIG. 9B shows a cross-sectional side view of FIG. 9A, with the cooperating tab 414 inside of channel 332 of the harness connection element 310. FIG. 9C shows a broken-out section view detail of FIG. 9A, with retention curve 332 on the snap spring 318 interfering with the head 418 of the cooperating tab 414, thus providing sufficient retention force to keep the cooperating element 410 engaged to the harness connection element 310 during use of the combined harness 300 and exoskeleton 400.

The connection element 330, shown in FIG. 5, may have similar features (funnel-like opening, retention flanges, snap spring) and operate in a similar fashion to connection element 310. Cooperating button-like tab 324 on the exoskeleton 400, shown in FIG. 6, may have similar features (major and minor diameters) as the cooperating tab 414.

To detach the exoskeleton 400 from the harness 300, while continuing to safely wear the harness 300, the worker Wo may simply reverse the process shown in FIG. 7 through FIG. 9C by pushing or pulling up on the exoskeleton 400 to “unsnap” the cooperating element 410 on the exoskeleton 400 from harness connection element 310. In addition or alternatively, the harness connectors 310, 330 may include may include locking elements that may automatically lock when the cooperating elements 410, 414 are received in the lower region of the harness connection elements 310, 330, and/or that may be manually actuated to release the cooperating elements 410, 414, e.g., to allow the exoskeleton 400 to be removed.

Where the harness 300 and exoskeleton 400 include multiple cooperating connectors, the connectors may be secured separately or simultaneously. For example, the user may position the exoskeleton 400 such that the back tab 414 is located over the back connector 310 on the harness 300, and then lower the exoskeleton 400 to direct the tab 414 into the harness connector 310. With the exoskeleton 400 now stabilized, the user may manipulate the ends of the hip strut 420 individually to engage the hip tabs 424 with the harness hip connectors 330, thereby securing the exoskeleton 400 to the harness 300 and, therefore, relative to the user's body. The arm support(s) on the exoskeleton 400 may then be used to support the user's arm(s), e.g., to provide an offset force that at least partially offsets gravitational force acting on the arms(s) as the user moves about and performs various activities, e.g., with the arm(s) extended, which may reduce fatigue and/or strain, as described in the references identified elsewhere herein.

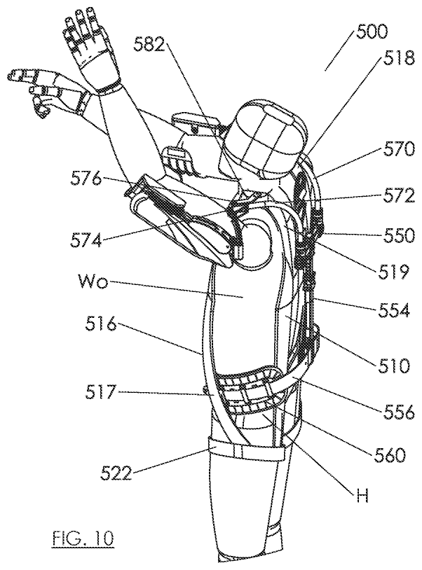

Turning to FIG. 10, another example of a combined exoskeleton and fall protection harness system 500 is shown, which includes harness 510 and exoskeleton 550. The system 500 has potentially desirable features to improve the comfort and functionality of the combined harness and exoskeleton. The previously described exoskeletons are worn on top of the fall-protection harness. In such a configuration, the exoskeleton does not directly contact the worker's body, but instead only contacts the fall-protection harness. This can interfere with the proper transfer of load to the worker's hips. In FIG. 10, the exoskeleton 550 is shown worn over, and optionally connected to, the fall protection harness 510, with the exception of the belt strut and hip pad portions of the exoskeleton 550. Belt strut 556 is attached to a hip pad 560, which is underneath a front strap 516 of the harness 510. The front strap 516 passes over the hip pad 560 at approximately location 517. In this way, the hip pad 560 can directly contact the worker's hip H without interference from front strap 516, and therefore can grip the worker's hip more securely. The hip pad 560 may be attached to the belt strut 556 and be independent of fall-protection harness 510, or may be attached to fall-protection harness 510, and have features that allow the belt strut 556 to connect to the harness 510, and/or otherwise transfer loads to the harness 510. Such features may include pockets, belts, loops, snaps, hooks, clips, hook/loop fasteners, adhesives, magnets, or any other suitable joining method. Whether attached to the exoskeleton or to the fall-protection harness, the hip pads directly contact the worker's hips instead of on the strap of the fall-protection harness.

The positioning of the exoskeleton contact surface intended for the hips underneath the straps of the fall-protection harness described above can also be used in the case of exoskeletons and fall-protection harnesses that are not attached, but are simply used together. In such cases, the hip pads would be attached to the exoskeleton, and the belt struts and hip pads would be configured to easily fit underneath existing fall-protection harness straps.

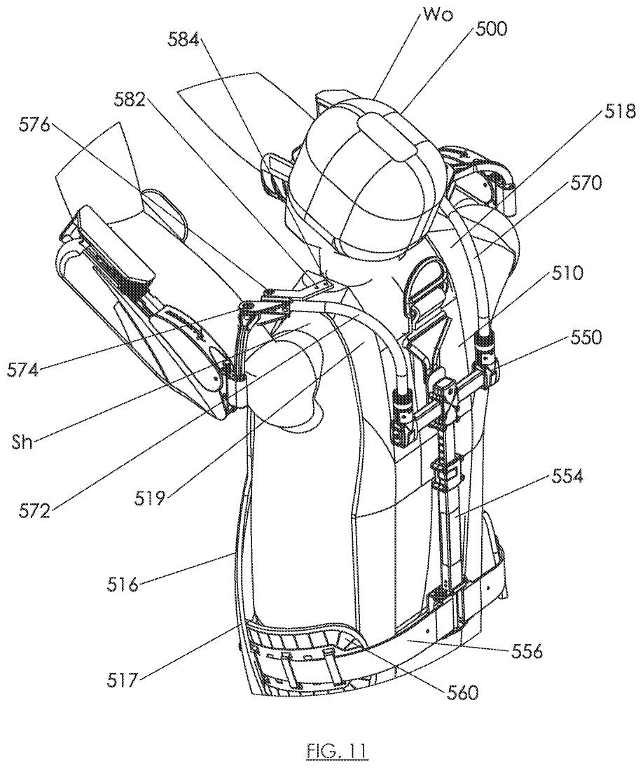

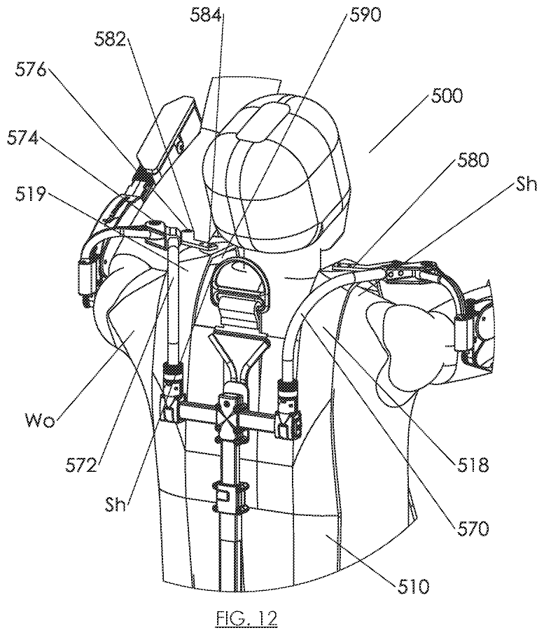

FIGS. 11 and 12 show perspective detail views another potentially desirable optional feature of a combined exoskeleton and fall-protection harness 500, such as the example shown in FIG. 10. Fall-protection harnesses are heavy, a function of the thick webbing and large steel components used in their construction. This weight is borne by the worker's shoulders, and can quickly become uncomfortable. The exoskeleton 550 shown in FIGS. 11 and 12 includes a feature that allows the weight of the fall-protection harness 510 to be off-loaded to the frame of the exoskeleton 550 and thereby to be transferred to the worker's hips, taking the load off of their shoulders. Exoskeleton 550 includes shoulder assemblies 570 and 572, which can provide structure adjacent the worker's shoulder Sh to which the fall-protection harness 510 can be attached (for brevity the components adjacent the worker's left shoulder are described, but the right shoulder maybe similarly equipped). If an exoskeleton does not normally have structure adjacent the worker's shoulder, auxiliary structure may be added. The strap bracket 582 may be attached the shoulder assembly 572 at attachment point 576, and may provide features 584 to which the shoulder strap 519 of the fall protection harness 510 can be attached. As shown in FIG. 12, a gap 590 may thus be created between the worker's shoulder Sh and shoulder strap 519, thereby eliminating the pressure on the shoulder. The gap 590 may in many cases be very small. In other cases, there may be no gap created at all, only a reduction in the load from the shoulder strap 519. Attachment feature(s) 584 may include one or more of snaps, belts, loops, hooks, clips, hook/loop fasteners, adhesive, magnets, or any other suitable joining method. Alternatively, the shoulder strap 519 may be simply looped over shoulder assembly 572, without the addition of a strap bracket 582 or other specialized component.

It will be appreciated that elements or components shown with any example herein are exemplary for the specific embodiment and may be used on or in combination with other examples disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A fall-protection harness for removably carrying an exoskeleton when worn by a user, comprising:
a pair of leg loops configured to be received around respective thighs of the user;
a back panel configured to be positioned against the user's back when the harness is worn;
one or more attachment rings for connecting to a lanyard or other structure;
a plurality of front straps extending from the back panel and attached to the leg loops, the front straps having a length such that the front straps extend over shoulders of the user to the leg loops when the harness is worn;
a plurality of back straps extending from the back panel and attached to the leg loops such that the back straps extend along the user's back when the harness is worn; and
one or more connectors for engaging one or more respective connectors on an exoskeleton to couple the exoskeleton to the harness.

2. The harness of claim 1, wherein the one or more connectors comprise a back connector on the back panel for engaging a corresponding connector on a back strut of the exoskeleton.

3. The harness of claim 2, wherein the one or more attachment rings comprise a D-ring permanently attached to the back panel and wherein the back connector is attached to the back panel immediately below the D-ring.

4. The harness of claim 1, further comprising a waist belt attached to one or both of the front straps and the back straps such that the waist belt extends around the user's waist or hips when the harness is worn, and wherein the one or more connectors comprise one or more hip connectors on the waist belt for engaging corresponding connectors on a belt strut of the exoskeleton.

5. The harness of claim 1, wherein the one or more connectors comprise hip connectors on the front straps for engaging corresponding connectors on a belt strut of the exoskeleton.

6. The harness of claim 1, wherein the one or more connectors comprise a funnel-shaped connector including an open upper end and a relatively narrow lower end into which a connector on the exoskeleton may be received.

7. The harness of claim 6, wherein the funnel-shaped connector includes a lock member that engages the connector on the exoskeleton when the connector is fully seated in the lower end to lock the connectors together.

8. The harness of claim 7, wherein the lock member is movable relative to the lower end to allow a user to disengage the connector on the exoskeleton from an opening in the funnel-shaped connector to release the connectors.

9. The harness of claim 7, wherein the lock member comprises a snap fitting.

10. The harness of claim 6, wherein the funnel-shaped connector comprises guides extending from the upper end to the lower end to guide the connector from the exoskeleton into a recess in the lower end.

11. The harness of claim 10, wherein the funnel-shaped connector further comprises a ramped tab extending along an upper edge of the upper end to guide the connector from the exoskeleton into the guides.

12-23. (canceled)

24. A system for supporting an arm of a user, comprising:
a harness configured to be worn on a body of a user;
an exoskeleton comprising an arm support including an arm rest for receiving the arm of the user and one or more compensation elements configured to apply an offset force to at least partially offset a gravitational force acting on the arm as the user moves and the arm support follows the movement of the user's arm; and
one or more cooperating connectors on the harness and exoskeleton for removably mounting the exoskeleton to the harness, each cooperating connector comprising:
an exoskeleton connector on the exoskeleton; and
a harness connector on the harness comprising an open upper end, a relatively narrow lower end defining a recess into which the exoskeleton connector may be received, guides extending from the upper end to the lower end to guide the exoskeleton connector into a recess, and a lock member that engages the exoskeleton connector when fully seated in the lower end to lock the cooperating connectors together.

25. The system of claim 24, wherein the exoskeleton connector comprises a tab including a shaft and an enlarged head, the shaft sized to be slidably received between the guides the recess, the head sized to be seated in the recess and engage the lock member.

26. The system of claim 24, wherein the one or more cooperating connectors comprise a back connector on the back panel, and a pair of hip connectors at locations on the harness corresponding to the user's hips when the harness is worn.

27. The system of claim 26, wherein each of the hip connectors are adjustable relative the waist belt.

28. The system of claim 26, wherein the back connector is attached to a back panel of the harness immediately below an attachment ring.

29. The system of claim 26, wherein the one or more cooperating connectors comprise a first tab coupled to a spine strut on the exoskeleton located to be received in the back connector.

30. The system of claim 29, wherein the one or more cooperating connectors further comprise hip tabs on a hip strut on the exoskeleton configured to be received in the hip connectors.

31. The system of claim 24, wherein the lock member is movable relative to the lower end to allow a user to disengage the snap fitting from the opening to release the connectors.

32-33. (canceled)

34. A method for coupling an exoskeleton to a fall-protection harness, comprising:
donning the fall-protection harness;
positioning the exoskeleton such that a back connector tab on a spine strut of the exoskeleton is located adjacent a funnel-shaped harness connector on a back panel of the harness;
lowering the exoskeleton relative to the harness to direct the back connector tab into the funnel-shaped harness connector; and
directing hip connector tabs on a hip strut of the exoskeleton into corresponding funnel-shaped harness connectors at hip locations on the harness.

35-41. (canceled)
